(19) United States
(12) Patent Application Publication
(10) Pub. No.: US 2023/0120868 A1
(43) Pub. Date: Apr. 20, 2023

(54) YOKE INSTALLATION AND REMOVAL ASSISTING DEVICE

(71) Applicants: Sebastian Vlad POPA, Edmonton (CA); Gareth MACHIN, Westerose (CA)

(72) Inventors: Sebastian Vlad POPA, Edmonton (CA); Gareth MACHIN, Westerose (CA)

(21) Appl. No.: 18/083,971

(22) Filed: Dec. 19, 2022

Related U.S. Application Data
(63) Continuation-in-part of application No. 17/334,943, filed on May 31, 2021.

(51) Int. Cl. F16D 65/00; B25B 27/14

(52) U.S. Cl. CPC F16D 65/0043; B25B 27/14; F16D 2250/0084

(57) ABSTRACT

A yoke installation and removal assisting device includes a structural body, a pair of yoke-receiving channels, a tool-receiving recess, and a pin-receiving channel. The pair of yoke-receiving channels terminally traverses into the structural body at a first end and is used to position a yoke. To prevent slipping during operation, a safety pin is preferably inserted through the pin-receiving channel and a pair of pin holes of the yoke. The pin-receiving channel laterally traverses into the structural body perpendicular to the pair of yoke-receiving channels and is used to hold the yoke against the structural body. The tool-receiving recess traverses into the structural body at a second end and is used to connect to an air tool or a manual ratchet. By operating the air tool/manual ratchet the yoke positioned within the structural body can be installed/removed.

### CROSS-REFERENCE TO RELATED APPLICATIONS

This application is a continuation-in-part of U.S. patent application Ser. No. 17/334,943, filed May 31, 2021, which is hereby incorporated by reference in its entirety.

### FIELD OF THE INVENTION

The present invention relates generally to the yoke assemblies, specifically to the installation and removal of yoke assemblies, more specifically to the installation and removal of brake yoke assemblies.

### BACKGROUND

Yoke installation and removal can be a time-consuming task due to a variety of reasons. Corrosion of connected components, limited accessibility to the yoke, and the inability to use an air tool are some of the notable reasons.

U.S. Pat. No. 8,763,224B2 discloses a pinion disassembly tool and method. The device utilizes a yoke holding plate that is sized to receive a socket wrench. The device has an overall planar shape and includes fastener apertures to connect with the yoke. The prior art describes a plate that is connected to a yoke with fasteners and can be used to remove a pinion. The prior art specifically focuses on disassembly. The use of an air tool and using a safety pin during operation are not described in this patent.

KR20130062497A discloses a cam yoke assembling system. In addition to being utilized for cam yoke assembling, a rotation restoring force generated by a torsion spring of the system can be used to compensate for the clearance between the support cam and a yoke plug. This disclosure does not focus on installing or removing a brake yoke assembly.

U.S. Pat. No. 2,239,192A describes a yoke and shaft assembly. In particular, the prior art describes an assembly that can be used to connect with a driving shaft and a universal joint yoke member. The assembly may be used to protect operational components from dirt and other external material. This patent does not describe a system and method of installing/removing a yoke. Furthermore, the patent does not describe having safety features such as a safety pin.

U.S. Pat. No. 5,220,716A describes a tool used to disassemble a universal joint with a first yoke and a second yoke. A pulling motion and a pushing motion are exerted in opposite directions to remove either the first yoke or the second yoke. The tool utilizes a cylinder/piston combination for disassembly purposes. The patent does not describe a process of being used for installation purposes. Moreover, the use of air tools and safety features are also not described in this patent.

U.S. Pat. No. 5,966,792A describes a tool for assembling and disassembling a universal joint. In doing so, the tool of the prior art utilizes two relatively movable components that move between two positions using a threaded screw. Furthermore, the prior art utilizes a guide pin during the assembly and disassembly process. The overall components used and the arrangement of the components are different in the prior art. Moreover, the ability to use an impact wrench is not specifically described in this patent.

KR20100006968U describes a device for assembling a pinion shaft for a differential device. The device may be used to prevent interference with the propeller shaft. This document does not describe a process of installing or removing a yoke with power tools or a manual ratchet. Furthermore, safety features are not described in the document.

U.S. Pat. No. 6,907,667B2 describes a method of assembling a portion of a universal joint such as a cross and a yoke. The method includes the steps of positioning a threaded fastener through an aperture, positioning the cross relative to the yoke, and installing a set of bearings. The patent does not describe a removal process or safety measures.

CN102360680A describes an assembly tool for a magnetic yoke which mainly comprises a connecting plate and a set of attaching plates. Each of the set of attaching plates is mounted to the connecting plate such that the overall assembly efficiency is improved and the overall cost is reduced. The document utilizes multiple components for assembly purposes. Furthermore, the document does not describe a possibility to be used with air tools and manual ratchets.

U.S. Pat. No. 9,010,208B2 describes a yoke assembly adapted for use in a rack and pinion steering gear assembly. The yoke assembly includes a yoke bearing, a spring, a yoke cover, and an automatic-adjusting mechanism. During vehicle operation, the automatic-adjusting mechanism and the spring are used to apply a biasing force against the yoke bearing. The patent does not specifically describe a tool that is used in installing and/or removing a yoke.

All documents cited here are incorporated by reference.

None of the above cited documents, alone or in combination disclose a comparable component arrangement to the currently disclosed embodiments of the present invention. Hence there remains need for a yoke installation and removal assisting device that allows the user to safely use an air tool or a manual tool on brake yoke assemblies.

### BRIEF SUMMARY

It is an object of the invention to provide a yoke installation and removal assisting device.

In accordance with an aspect of the invention there is provided a yoke installation and removal assisting device, said device comprising: a structural body, said structural body having a length extending between a first end and a second end; a pair of yoke-receiving channels traversing into said structural body at said first end and partially traverses through said length of said structural body; and a tool-receiving recess centrally traversing into said structural body at said second end, wherein said structural body is rotated to remove or install said yoke.

In accordance with another aspect of the invention there is provided a method of installing or removing a yoke using the device as described above, said method comprising the steps of: inserting a yoke into said pair of yoke-receiving channels, connecting an installation/removal tool to said structural body at said tool-receiving recess; concentrically aligning said pin-receiving channel with a pair of pin holes of the yoke; slidably positioning a safety pin into said pin-receiving channel and through said pair of pin holes to connect said yoke and structural body; and activating said installation/removal tool to rotate said structural body and said yoke.

In accordance with another aspect, there is provided a yoke installation and removal assisting device, said device comprising: a structural body, said structural body having a length extending between a first end and a second end; a pair of yoke-receiving channels extending within said structural body from said first end and partially traversing through said length of said structural body; and a tool-receiving recess centrally traversing into said structural body at said second end, wherein said structural body is rotated to remove or install said yoke.

In one embodiment, the structural body is cylindrical in shape.

In one embodiment, an overall cross-section of each of said pair of yoke-receiving slots is rectangular in shape.

In one embodiment, the tool-receiving recess is cubical in shape.

In one embodiment, the yoke installation and removal assisting device further comprises: a first engagement cavity and a second engagement cavity in said tool-receiving recess; said first engagement cavity traversing from a first lateral surface of said tool-receiving recess to a first lateral side of the structural body; and said second engagement cavity traversing from a second lateral surface of the tool-receiving recess to a second side of the structural body, wherein said first lateral surface and said second lateral surface are positioned opposite to each other.

In one embodiment, the yoke installation and removal assisting device further comprises: a pin-receiving channel laterally traversing through said structural body adjacent said first end, the pin-receiving channel comprising a first opening on a first lateral side of the structural body, a second opening on a second lateral side of the structural body opposite the first opening, and laterally extending through the pair of yoke-receiving channels; the pin-receiving channel configured to be concentrically alignable with a pair of pin holes on a yoke upon the yoke being engaged in the pair of yoke-receiving channels.

In one embodiment, a cross-section of said pin-receiving channel is circular in shape.

In one embodiment, the structural body is manufactured from tool steel.

In one embodiment, the structural body is manufactured from carbon fiber.

In one embodiment, the structural body is manufactured from aluminum.

In accordance with another aspect, there is provided a method of installing or removing a yoke, the method comprising the steps of: inserting the yoke into said pair of yoke-receiving channels, connecting an installation/removal tool to said structural body at said tool-receiving recess; and activating said installation/removal tool to rotate said structural body and said yoke.

In one embodiment, the method of installing or removing a yoke further comprises the step, between said aligning and said positioning, of: concentrically aligning said pin receiving channel with the pair of pin holes of the yoke; slidably positioning a safety pin into said pin receiving channel and through said pair of pin holes to connect said yoke and structural body, and securing it with a locking mechanism.

In one embodiment, the installation/removal tool is an impact wrench.

In one embodiment, the installation/removal tool is a manual ratchet.

In one embodiment, the yoke installation and removal assisting device comprises a safety pin configured to be inserted in the pin-receiving channel, and a locking mechanism to secure the safety pin within the pin-receiving channel.

In one embodiment, the safety pin comprises: an elongated body configured to fully engage the pin-receiving channel at least from the first opening to the second opening; and a head portion at a first end of the elongated body, the head portion extending laterally from the end of the elongated body, and comprising a concavely curved inner surface configured to fittingly engage the first side of the structural body upon the elongated body being fully engaged in the pin-receiving channel.

In one embodiment, the safety mechanism comprises: a washer member, the washer member comprising a hole configured to receive therethrough the elongated body of the safety pin, and a curved inner surface configured to fittingly engage the curvature the second side of the structural body upon the safety pin being secured within the pin receiving channel.

In one embodiment, the elongated body comprises a laterally oriented fastener channel proximate a second end thereof, and wherein the locking mechanism further comprises a fastener configured to engage the lateral fastener channel therethrough upon the elongated member being fully engaged in the pin receiving channel.

In one embodiment, the fastener is a pin comprising a spring-loaded detent mechanism.

In one embodiment, a second end of the elongated body is threaded, and the locking mechanism further comprises a nut configured to removably rotationally engage the threaded end of the second end of the elongated body to secure the safety pin the in pin-receiving channel.

The advantages and features of the present invention will become better understood with reference to the following more detailed description and claims taken in conjunction with the accompanying drawings in which like elements are identified with like symbols.

To easily identify the discussion of any particular element or act, the most significant digit or digits in a reference number refer to the figure number in which that element is first introduced.

### BRIEF DESCRIPTION OF THE SEVERAL VIEWS OF THE DRAWINGS

FIG. 1 is a perspective view of the yoke installation and removal assisting device of the present disclosure.

FIGS. 2A, 2B and 2C are a perspective view, a bottom cross-sectional view and a side cross-sectional view, respectively, illustrating a the yoke installation and removal assisting device, wherein a pair of yoke-receiving channels is shown.

FIG. 3 is a top view of the yoke installation and removal assisting device of the present disclosure.

FIG. 4 is a first side view of the yoke installation and removal assisting device of the present disclosure.

FIG. 5 is a second side view of the yoke installation and removal assisting device of the present disclosure.

FIG. 6 is a perspective view illustrating a negative space within the yoke installation and removal assisting device.

FIG. 7 is a front view illustrating the negative space within the yoke installation and removal assisting device.

FIG. 8 is a side view illustrating the negative space within the yoke installation and removal assisting device.

FIG. 9 is a top view illustrating the negative space within the yoke installation and removal assisting device.

FIGS. 10A and 10B are perspective views illustrating a yoke and the yoke installation and removal assisting device.

FIG. 11 is a perspective view illustrating the yoke and the yoke installation and removal assisting device, wherein the yoke is inserted into the pair of yoke-receiving channels.

FIGS. 12A and 12B are perspective views illustrating a yoke and the yoke installation and removal assisting device.

FIG. 13 is a perspective view illustrating the yoke and the yoke installation and removal assisting device, wherein the yoke is inserted into the pair of yoke-receiving channels.

FIG. 14 is a perspective view illustrating an installation/removal tool being attached to the structural body.

FIGS. 15A, 15B and 15C are perspective views illustrating a pin and a locking mechanism to be used with the yoke installation and removal assisting device, in accordance with one embodiment.

FIGS. 16A and 16B are perspective views illustrating another safety pin and locking mechanism, in accordance with another embodiment.

FIG. 17A is perspective view of a yoke installation/removal tool having a tool engagement member comprising spring-loaded detente balls. FIG. 17B is a cross-sectional side view of the tool engagement member inside the tool-receiving recess of the yoke installation and removal assisting device showing the detente balls engaged in the engagement cavities of the tool-receiving recess, in accordance with one embodiment.

### DETAILED DESCRIPTION

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

The present disclosure describes a yoke installation and removal assisting device that may be used with a manual ratchet or an air tool. By utilizing the device described in the present disclosure, a yoke can be installed or removed regardless of the condition of the components or the positioning of the yoke. As a result, the overall time required for installing or removing a yoke may be significantly reduced.

The yoke installation and removal assisting device includes a structural body and a safety pin. The yoke that needs to be installed or removed is positioned into a pair of yoke-receiving channels that traverses the structural body of an embodiment of the invention as disclosed herein. The safety pin, which is inserted into the structural body perpendicular to the yoke, may be used prevent the yoke from slipping during the installation process and/or the removal process. When the yoke and the structural body are secure, an impact wrench or air tool may be connected to a terminal end of the structural body. The structural body and the pair of yoke-receiving channels may be configured to receive all yoke types. Furthermore, the safety pin may also be sized to fit different yoke types.

The embodiments of the invention as described herein relate to a yoke installation and removal assisting device that may be used with a manual ratchet or an impact wrench. By utilizing the device of the present disclosure, a user may install or remove a yoke with convenience regardless of the status of the components or the accessibility to the components. For example, if a corroded yoke cannot be removed manually, the device of the present disclosure may be used with an impact wrench to remove the corroded yoke.

Normally access is limited so a larger tool that would deliver more torque is not feasible. The various embodiments of the brake yoke tool disclosed herein allows use of powered tool and delivery of torque to confined area. Established disassembly and reassembly procedures are by hand tools only. Hence, enabling the device and procedure to be done with the assistance of power tools is greatly advantageous in both speed, efficacy and safety.

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

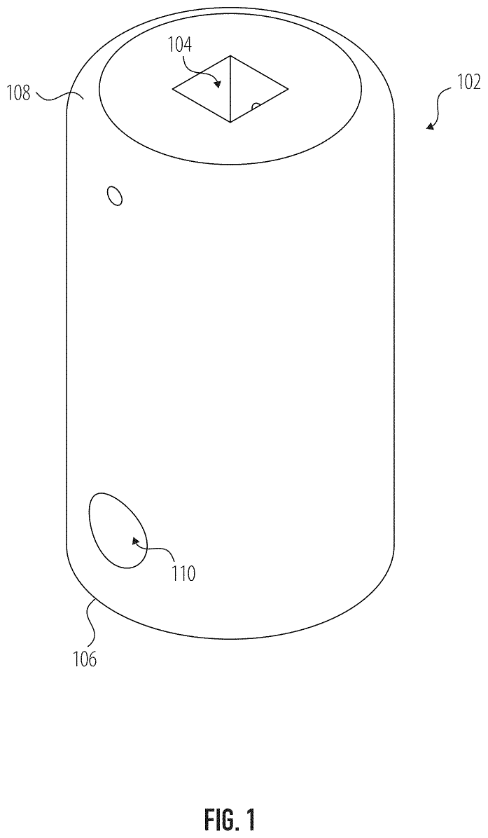

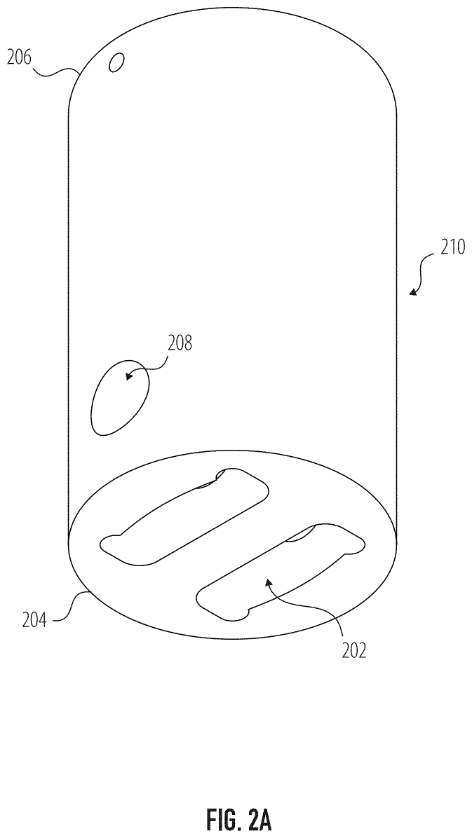

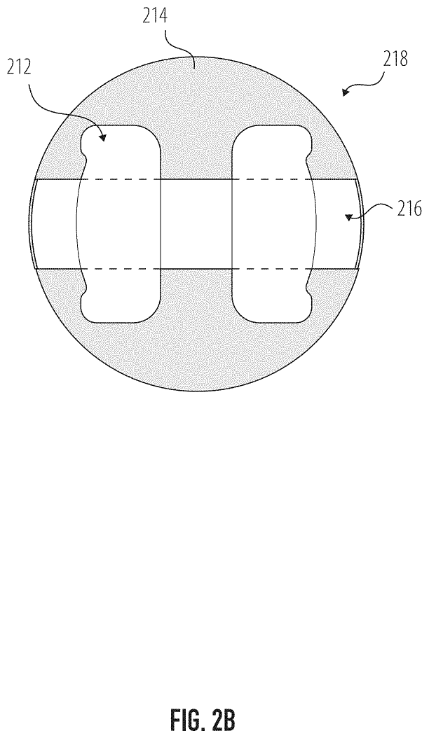

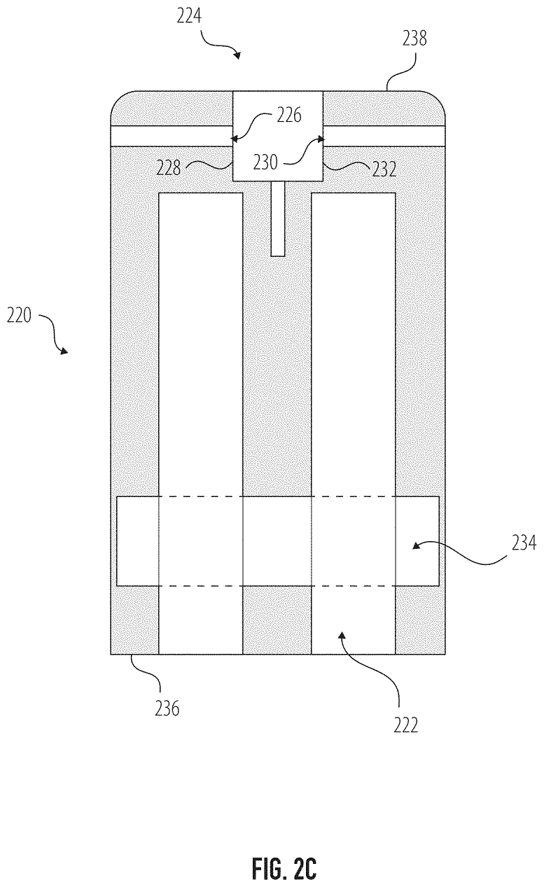

FIG. 1 and FIG. 2A illustrate a perspective view of the yoke installation and removal assisting device of the present disclosure. As seen in FIG. 1 and FIG. 2A, the yoke installation and removal assisting device comprises a structural body (102 in FIG. 1, and 210 in FIG. 2A), a pair of yoke-receiving channels 202, and a tool-receiving recess 104. As seen in FIGS. 1 and 2A, the structural body (102, 210), which is cylindrical in shape in a preferred embodiment, extends from a first end (106 in FIG. 1, 206 in FIG. 2A) to a second end (108 in FIG. 1, 208 in FIG. 2A). A length between the first end (106, 206) and the second end (108, 208) can vary in different embodiments. More specifically, the length between the first end (106, 206) and the second end (108, 206) can vary according to a length of the yoke which needs to be installed or removed. A pin-receiving channel is also shown (110 in FIG. 1, 208 in FIG. 2A).

Further referring to FIG. 1, the tool-receiving recess 104 centrally traverses into the structural body 102 at the second end 108. The tool-receiving recess 104, which is cubical in shape in one particular embodiment, is used to connect to a yoke installation/removal tool. In particular, the positioning and shape of the tool-receiving recess 104 allows the user to connect an impact wrench or a manual ratchet for installation and removal processes.

As seen in FIGS. 2A, 2B and 2C, the pair of yoke-receiving channels (202 in FIG. 2A, 212 in FIG. 2B, and 222 in FIG. 2C) traverses into the structural body (210 in FIG. 2A, 218 in FIG. 2B, and 220 in FIG. 2C) at the first end (204 in FIG. 2A, 214 in FIG. 2B, and 236 in FIG. 2C). In a preferred embodiment, an overall cross-section of each of the pair of yoke-receiving channels (202, 212, 222) is rectangular in shape, as shown in FIG. 2C for example. However, to receive a wide variety of yokes, the overall cross-section of each of the pair of yoke-receiving channels (202, 212, 222) can be different in other embodiments of the present disclosure. To position the yoke within the structural body (210, 218, 220), the pair of yoke-receiving channels (202, 212, 222) partially traverses through a length of the structural body (210, 218, 22), wherein the length of the structural body (210, 218, 220) extends from the first end (204 in FIG. 2A, 214 in FIG. 2B, and 236 in FIG. 2C) to the second end (206 in FIG. 2A, and 238 in FIG. 2C). To receive yokes of different lengths, an overall depth of the pair of yoke-receiving channels (202, 212, 222) can vary in embodiments of the present disclosure. Furthermore, a distance between each of the pair of yoke-receiving channels (202, 212, 222) can also vary in different embodiments of the present disclosure. For example, if the yoke installation and removal device is used with a wide yoke, a channel gap between each of the pair of yoke-receiving channels (202, 212, 222) will be greater than a channel gap when the yoke installation and removal device is used with a narrower yoke. FIGS. 2B and 2C also show the pin-receiving channel (216 in FIG. 2B, 234 in FIG. 2C).

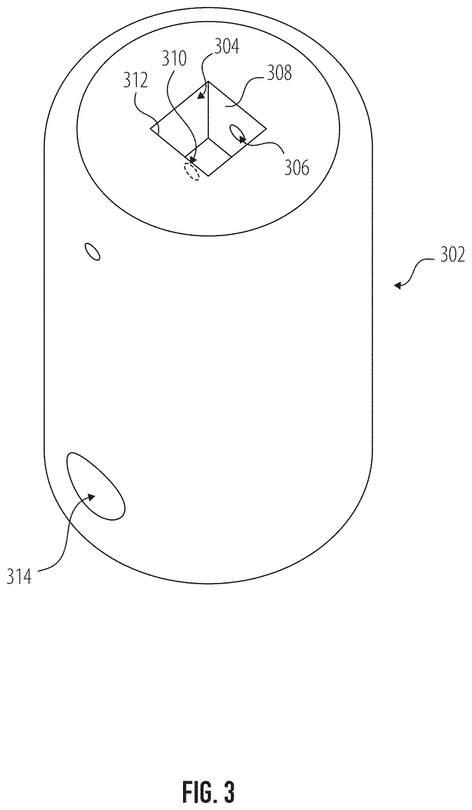

FIG. 3 is a top perspective view illustrating the tool-receiving recess 304 in the structural body 302 of the present disclosure. To establish a secure connection with an installation/removal tool, which can be, but is not limited to, an impact wrench or a manual ratchet, the tool-receiving recess 304 (also shown in FIG. 2C as 224) comprises a first engagement cavity 306 (226) second engagement cavity 310 (230). More specifically, the first engagement cavity 306 (226) and the second engagement cavity 310 (230) may be used to engage with a spring-loaded locking detent mechanism of the installation/removal tool. The first engagement cavity 306 (226) traverses into a first lateral surface 308 (228) of the tool-receiving recess 304 (224) which is cubical in shape. The second engagement cavity 310 (230) traverses into a second lateral surface 312 (232) of the tool-receiving recess 304 (224), wherein the first lateral surface 308 (228) and the second lateral surface 312 (232) are positioned opposite to each other. Also shown in FIG. 3 is the pin-receiving channel 314.

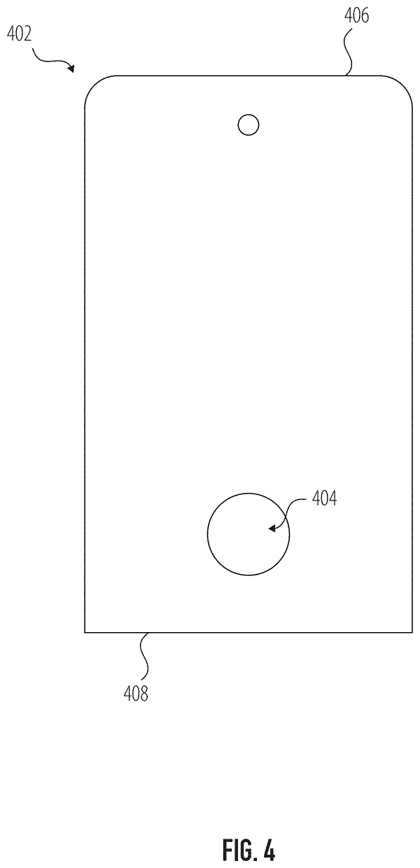

As seen in FIG. 4, the yoke installation and removal assisting device further comprises a pin-receiving channel 404 which laterally traverses through the structural body 402 adjacent the first end 408, wherein the pin-receiving channel 404 is positioned perpendicular to the pair of yoke-receiving channels 202 seen in FIG. 2A. A locking mechanism may be used to secure the safety pin within the pin-receiving channel 404. The locking mechanism may be, but is not limited to, a spring-loaded locking detent mechanism or a magnetic locking mechanism. Also shown in FIG. 4 is the second end 406 of the structural body 402.

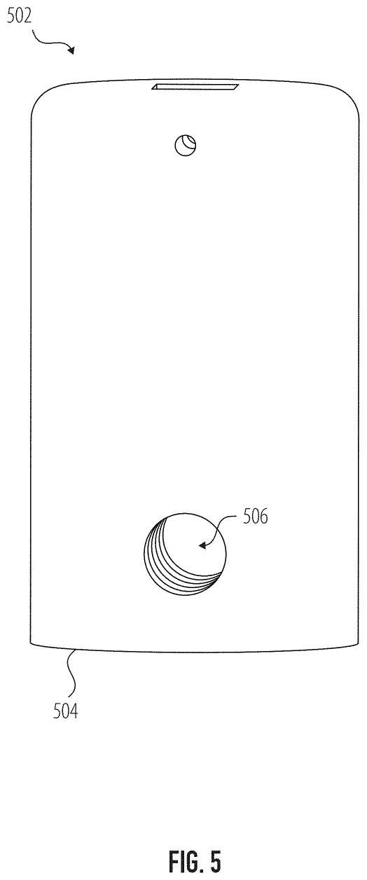

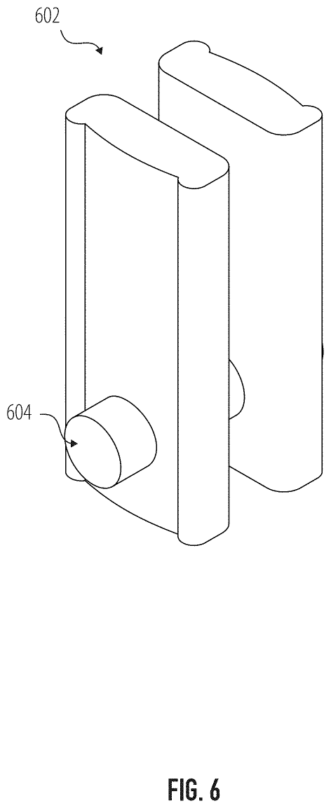

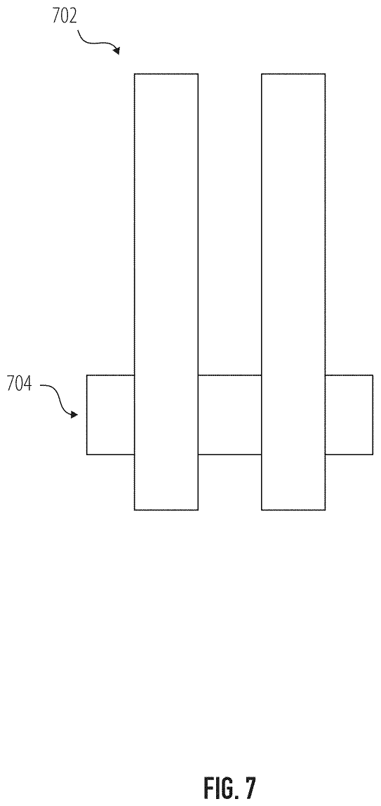

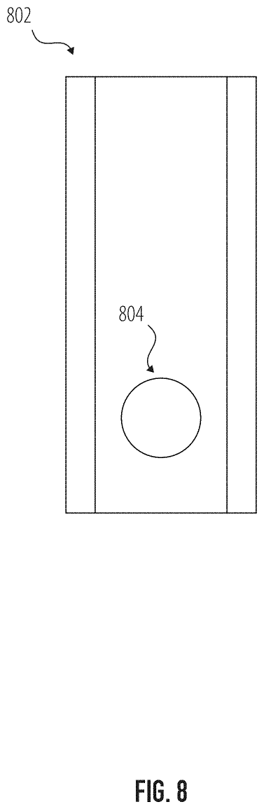

As seen in FIG. 5, FIG. 6, FIG. 7, and FIG. 8, in a preferred embodiment, a cross-section of the pin-receiving channel 506 is circular in shape. Therefore, if a safety pin is used during installation or removal of the yoke, the pin-receiving channel 506 is concentrically aligned with a pin hole of the yoke creating a channel for the safety pin. Even though a circular cross-section is preferred for the pin and the pin-receiving channel 506, in other embodiments, a hexagonal cross-section or other comparable shape may also be used for the pin and the pin-receiving channel 506. In a preferred embodiment, a diameter of the pin-receiving channel 506 seen in FIG. 5 in the structural body 502 adjacent the first end 504 may be within a range of 0.25-1.00 inches. Also shown in FIGS. 6, 7, and 8, respectively, are the yoke-receiving channels (602, 702 and 802) and the pin-receiving channel (604, 704, and 804).

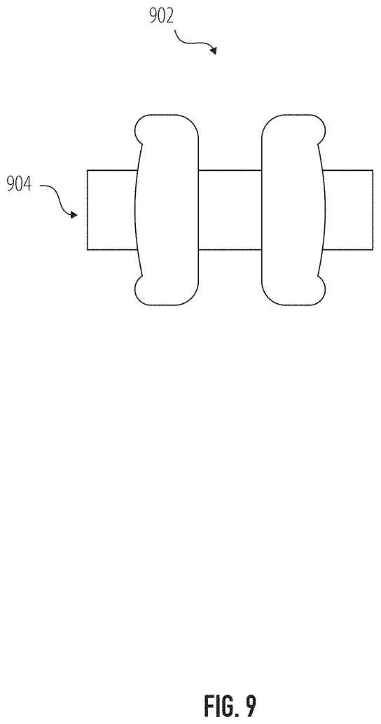

FIG. 9 is another illustration of the pin-receiving channel 904 intersecting the pair of yoke-receiving channels 902. When the yoke is inserted into the pair of yoke-receiving channels 202 of FIG. 2A, a safety pin is preferably positioned into the pin-receiving channel 404 such that the yoke is held against the structural body 402 to prevent the yoke from slipping during installation or removal.

FIGS. 10A and 10B illustrate the yoke 1008, the structural body 1002, the pair of yoke-receiving channels 1004, and the pin-receiving channel 1006. In a method of installing or removing a yoke using the device of the present disclosure, as an initial step, the yoke is inserted into the pair of yoke-receiving channels 1004 of FIG. 10A and FIG. 10B. In this specific embodiment, for durability purposes, the structural body 1002, seen in FIG. 10A and FIG. 10B is manufactured from tool steel. However, in other embodiments, the structural body 1002 may also be manufactured from material that may be, but is not limited to, carbon fiber or aluminum.

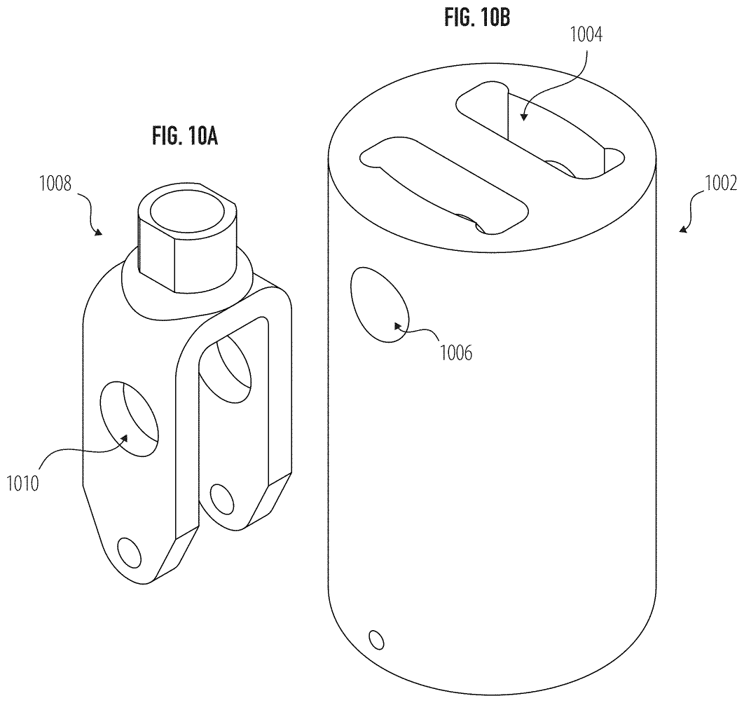

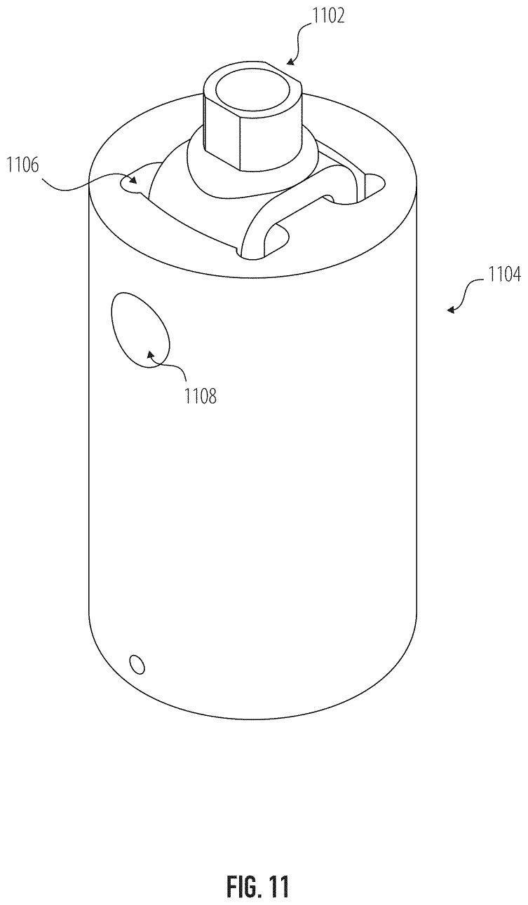

FIG. 11 is an illustration of when the yoke 1102 is inserted into the pair of yoke-receiving channels 1106 of the structural body 1104, wherein the yoke 1102 is inserted such that a pair of pin holes 1010 of the yoke 1008, seen in FIG. 10A, is concentrically aligned with the pin-receiving channel 1006. If a safety pin is used, the safety pin may be inserted into the pin-receiving channel 1006 (1108 in FIG. 11) such that the safety pin, the pin-receiving channel 1006, and the pair of pin holes 1010 are concentrically aligned to each other.

FIG. 12A and FIG. 12B are another illustration of the yoke 1202 (FIG. 12A), the structural body 1204 (FIG. 12B), the pair of yoke-receiving channels 1208, and the pin-receiving channel 1206, wherein the yoke 1202 is a brake chamber yoke. In a method of installing or removing the yoke 1202 using the device of the present disclosure, as an initial step, the yoke 1202 is inserted into the pair of yoke-receiving channels 1208.

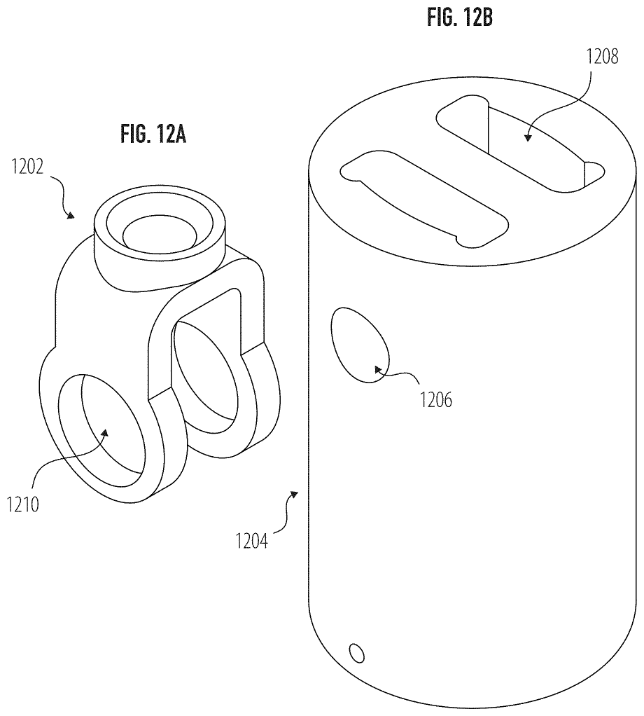

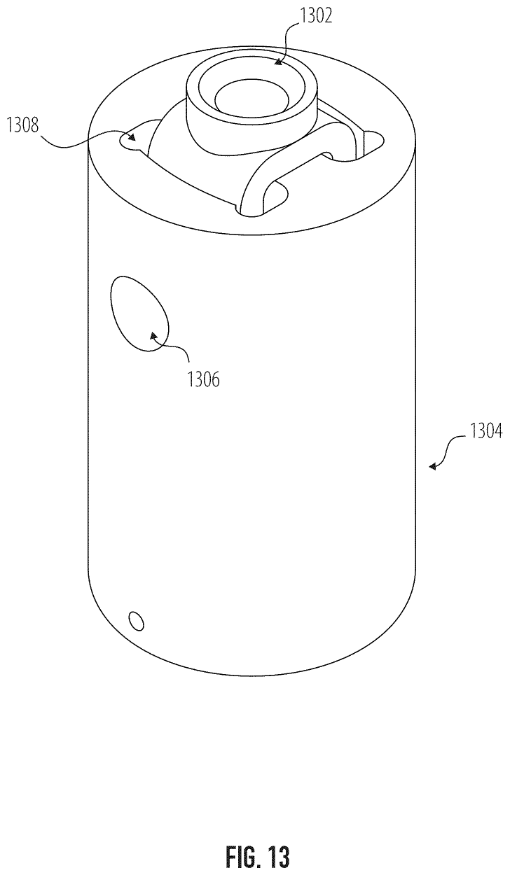

FIG. 13 is an illustration of when the yoke 1302 of the structural body 1304 is inserted into the pair of yoke-receiving channels 1308. The yoke 1202 is inserted such that the pair of pin holes 1210 of the yoke 1202, seen in FIG. 12A, are concentrically aligned with the pin-receiving channel 1206. If a safety pin is used, the safety pin may be inserted into the pin-receiving channel 1206 (1306 in FIG. 13) such that the safety pin, pin-receiving channel 1206, and the pair of pin holes 1210 are concentrically aligned to each other.

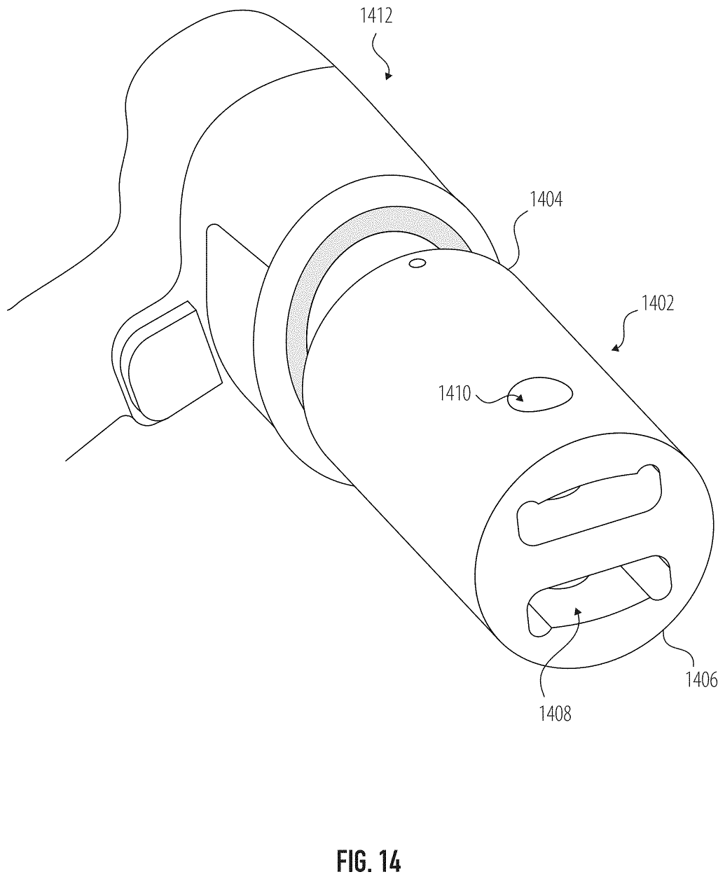

Referring to FIG. 11, after the yoke 1102 has been inserted into the pair of yoke-receiving channels 1106, in a subsequent step of the method, an installation/removal tool 1412 (as shown in FIG. 14) is connected to the structural body 1104 at the tool-receiving recess 104 shown in FIG. 1.

In one embodiment, as seen in FIG. 14, the installation/removal tool 1412 can be an impact wrench. In another embodiment, the installation/removal tool 1412 of FIG. 14 can be a manual ratchet. After the installation/removal tool 1412 is attached to the structural body 1402 on the second end 1404 thereof, the user may proceed to install the yoke 1102 of FIG. 11 by engaging the yoke in the yoke-receiving channels 1408 located on the first end 1406 (and optionally securing it via a pin engaged in the pin-receiving channel 1410) and activating the installation/removal tool 1412 to rotate the structural body 1402 in a clockwise direction. In another aspect, the user may proceed to remove the yoke 1102 of FIG. 11 by activating the installation/removal tool 1412 to rotate the structural body 1402 in a counterclockwise direction.

The yoke installation and removal assisting device of the present disclosure may be used to install a yoke onto or remove a yoke from a component that can be, but is not limited to, a driveshaft or a brake chamber. By utilizing the yoke installation and removal assisting device of the present disclosure, a yoke can be installed or removed conveniently with the use of an air tool or a manual ratchet.

As discussed above, in some embodiments, the tool is configured to have a safety pin receiving channel. While the tool may be used without using this feature, for example by the user exerting pressure against the tool to prevent the yoke from leaving the yoke-receiving channels, as will be appreciated by the skilled person in the art, in some case, a safety pin may be used to provide additional safety and avoid potential injuries. Typically, the safety pin is configured, as can be reasonably deduced by the person skilled in the art, to engage the pin-receiving channel and the pin holes of the engaged yoke so as to prevent the yoke from leaving the yoke-receiving channel upon the tool being rotated during installation or removal.

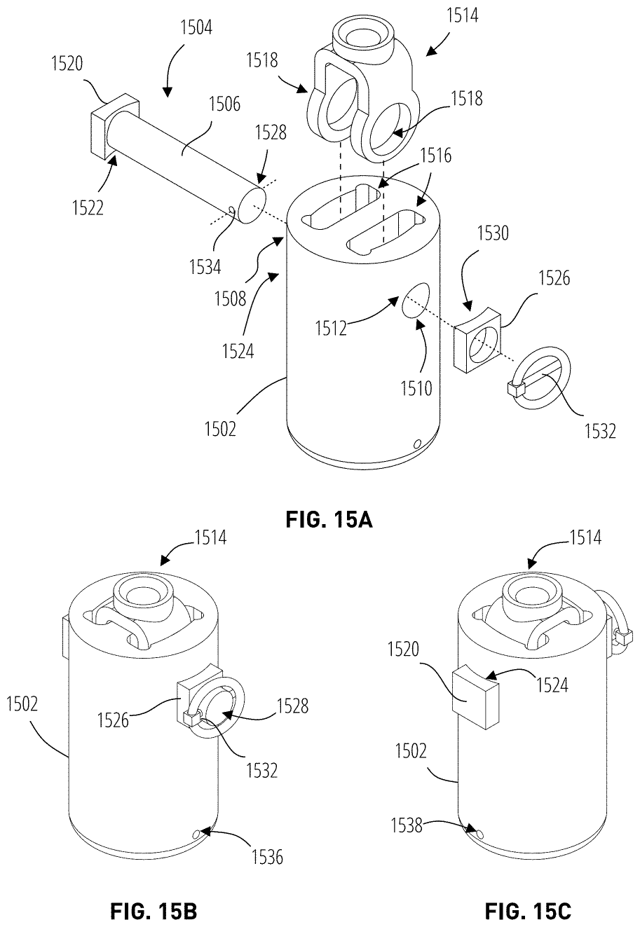

For example, FIGS. 15A-C are perspective views illustrating, in accordance with one embodiment, the installation/removal assisting device 1502 further comprising a pin 1504 and a locking mechanism for securing the pin 1504. The pin 1504 typically comprises an elongated body 1506 configured to fully and fittingly engage the pin-receiving channel from at least an opening 1508 on a first side 1502 of the structural body 1502 to a second opening 1510 on the second side 1512 of the structural body 1502 upon the yoke 1514 being engaged in the pair of yoke-receiving channels 1516. Thus the elongated body 1506 simultaneously engages the pin holes 1518 of the engaged yoke 1514, thereby preventing the yoke from disengaging from the tool. Moreover, in some embodiments, the pin 1504 may further comprise a head portion 1520 at a first end 1522 thereof, the head portion 1520 extending laterally from the elongated body 1506 to prevent the end 1522 from moving inside the structural body 1502 upon insertion, and to exert pressure on the structural body 1502. In this example, the head portion 1520 further comprises a curved surface 1522 configured to fittingly engage the corresponding curvature of a first side 1524 of the structural body 1502 around the opening 1508. Similarly, in some embodiments, the pin 1504 may further comprise a washer element 1526 configured to receive the end 1528 of the elongated member 1506 therethrough, the washer element 1526 also comprising a curved surface 1530 configured to fittingly engage the curved surface on the second side 1512 of the structural body 1502. The effect of the curved surfaces 1522 and 1530 may include improving engagement of the pin 1504 to the sides of the structural body 1502, and to prevent undue rotational motion of the elongated body 1506.

Furthermore, in this exemplary embodiment, as shown in FIGS. 15A, 15B and 15C, the locking mechanism comprises a fastener 1532 (e.g., a pin comprising a spring-loaded detent mechanism or the like) configured to fully engage a corresponding laterally positioned channel 1534 on the end 1528 of the elongated member 1506. FIGS. 15B and 15C show the safety pin 1504 fully engaged in the tool and secured via the fastener 1532. Typically, the length of the elongated member 1506 and the position of the lateral channel 1534 will be such so as to minimize motion of the pin 1504 along its length upon being fully engaged and secured (e.g., to provide a “snug” fit). The skilled person in the art will also appreciate that other types of fasteners may readily be used to engage the channel 1534 and secure the pin 1504.

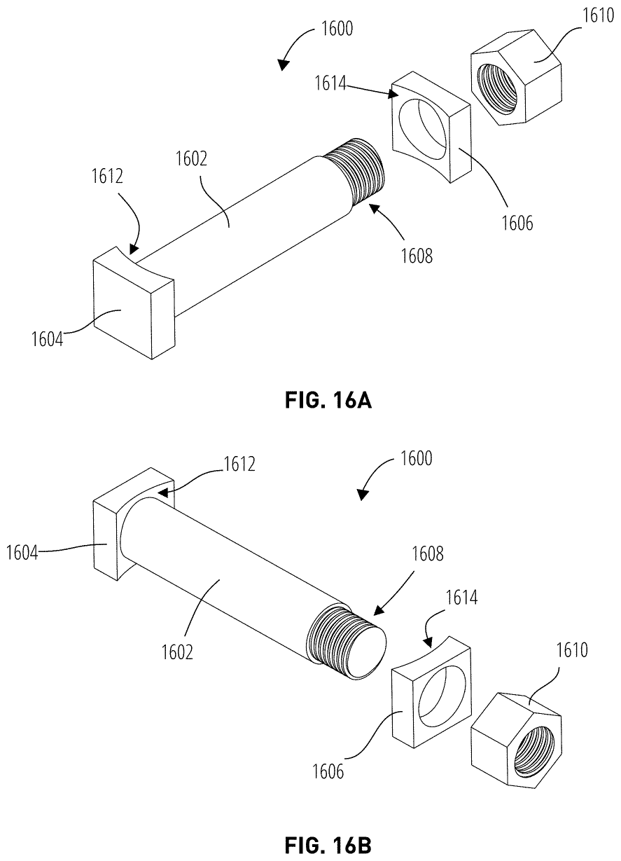

In some embodiments, different means for locking the safety pin may be used. For example, FIG. 16A and FIG. 16B are two perspective views illustrating a safety pin 1600 comprising a different locking mechanism than the one illustrated in FIGS. 15A-15C. In this embodiment, the pin 1600 is configured to be used as illustrated previously, and similarly comprises an elongated body 1602, a head portion 1604 and a washer element 1606, as described above. However, in this example, the second end 1608 of the elongated body 1602 is threaded (instead of comprising a lateral fastener channel). The locking mechanism comprises a nut 1610 configured to reversibly and rotationally engage the treaded end 1608 of the elongated body 1602 upon the safety pin 1600 being fully engaged in the pin-receiving channel. The nut 1610 is rotationally engaged so as to exert pressure on the washer element 1606, thereby having the curved surfaces 1612 and 1614 grip the outer surface of the structural body, locking the safety pin in place.

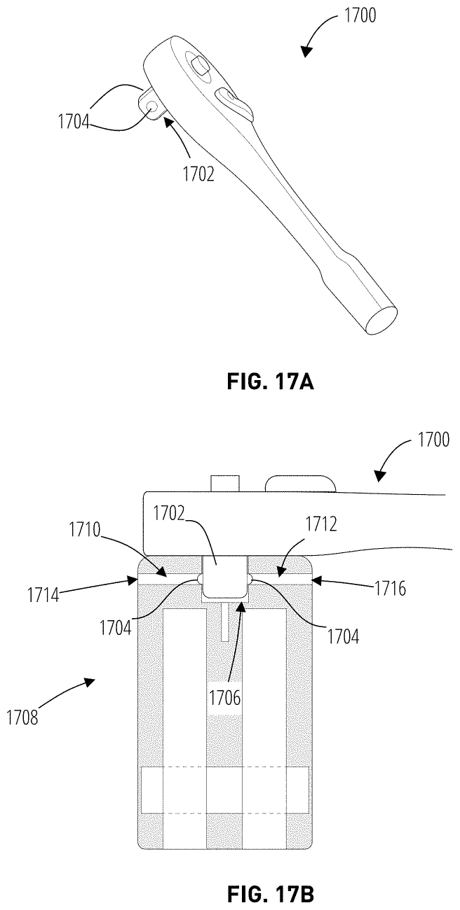

FIG. 17A is a perspective view illustrating a yoke installation/removal tool 1700 comprising an engagement member 1702 having a spring-loaded detente locking mechanism. In this example, the tool 1700 is a manual ratchet as an example only, and it will be appreciated that other tools having similar engagement members may also be used, for example an impact wrench or the like. In this example, the locking mechanism of the engagement member 1702 takes the form of a pair of spring-loaded detente balls 1704 located on two opposing sides of the engagement member 1702. FIG. 17B shows the engagement member 1702 being inserted in the tool-receiving recess 1706 of the structural body 1708. The two detente balls 1704 of the engagement member 1702 are configured to simultaneously engage the first engagement cavity 1710 and the second engagement cavity 1712, thereby (removably) locking the tool in place. In some embodiment, the first engagement cavity 1710 extends all the way to the outer surface of the structural body 1708 at location 1714, while the second engagement cavity 1712 similarly extends to the outer surface on an opposite side of structural body 1708 at location 1716. This creates two openings or holes 1714 and 1716 on opposite sides of the structural body (also shown for example as holes 1536 and 1538 in FIGS. 15B and 15C, for example). These may advantageously provide, for example, a visual point of reference to enable the user to see when the structural body is being rotated and to visualize how much rotation is being imparted.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A yoke installation and removal assisting device, said device comprising:
a structural body, said structural body having a length extending between a first end and a second end;
a pair of yoke-receiving channels extending within said structural body from said first end and partially traversing through said length of said structural body; and
a tool-receiving recess centrally traversing into said structural body at said second end, wherein said structural body is rotated to remove or install said yoke.

2. The yoke installation and removal assisting device of claim 1, wherein said structural body is cylindrical in shape.

3. The yoke installation and removal assisting device of claim 1, wherein an overall cross-section of each of said pair of yoke-receiving slots is rectangular in shape.

4. The yoke installation and removal assisting device of claim 1, wherein said tool-receiving recess is cubical in shape.

5. The yoke installation and removal assisting device of claim 4, further comprising:
a first engagement cavity and a second engagement cavity in said tool-receiving recess;
said first engagement cavity traversing from a first lateral surface of said tool-receiving recess to a first lateral side of the structural body; and
said second engagement cavity traversing from a second lateral surface of the tool-receiving recess to a second side of the structural body,
wherein said first lateral surface and said second lateral surface are positioned opposite to each other.

6. The yoke installation and removal assisting device of claim 2, further comprising:
a pin-receiving channel laterally traversing through said structural body adjacent said first end, the pin-receiving channel comprising a first opening on a first lateral side of the structural body, a second opening on a second lateral side of the structural body opposite the first opening, and laterally extending through the pair of yoke-receiving channels; the pin-receiving channel configured to be concentrically alignable with a pair of pin holes on a yoke upon the yoke being engaged in the pair of yoke-receiving channels.

7. The yoke installation and removal assisting device of claim 6, wherein a cross-section of said pin-receiving channel is circular in shape.

8. The yoke installation and removal assisting device of claim 1, wherein said structural body is manufactured from tool steel.

9. The yoke installation and removal assisting device of claim 1, wherein said structural body is manufactured from carbon fiber.

10. The yoke installation and removal assisting device of claim 1, wherein said structural body is manufactured from aluminum.

11. A method of installing or removing a yoke using the device of claim 6, said method comprising the steps of:
inserting the yoke into said pair of yoke-receiving channels,
connecting an installation/removal tool to said structural body at said tool-receiving recess; and
activating said installation/removal tool to rotate said structural body and said yoke.

12. The method of installing or removing a yoke using the device of claim 11, further comprising the step, between said aligning and said positioning, of:
concentrically aligning said pin receiving channel with the pair of pin holes of the yoke;
slidably positioning a safety pin into said pin receiving channel and through said pair of pin holes to connect said yoke and structural body, and securing it with a locking mechanism.

13. The method of installing or removing a yoke using the device of claim 11, wherein said installation/removal tool is an impact wrench.

14. The method of installing or removing a yoke using the device of claim 11, wherein said installation/removal tool is a manual ratchet.

15. The yoke installation and removal assisting device of claim 6, further comprising a safety pin configured to be inserted in the pin-receiving channel, and a locking mechanism to secure the safety pin within the pin-receiving channel.

16. The yoke installation and removal assisting device of claim 15, the safety pin comprising:
an elongated body configured to fully engage the pin-receiving channel at least from the first opening to the second opening; and
a head portion at a first end of the elongated body, the head portion extending laterally from the end of the elongated body, and comprising a concavely curved inner surface configured to fittingly engage the first side of the structural body upon the elongated body being fully engaged in the pin-receiving channel.

17. The yoke installation and removal assisting device of claim 16, the safety mechanism comprising:
a washer member, the washer member comprising a hole configured to receive therethrough the elongated body of the safety pin, and a curved inner surface configured to fittingly engage the curvature the second side of the structural body upon the safety pin being secured within the pin receiving channel.

18. The yoke installation and removal assisting device of claim 17, wherein the elongated body comprises a laterally oriented fastener channel proximate a second end thereof, and wherein the locking mechanism further comprises a fastener configured to engage the lateral fastener channel therethrough upon the elongated member being fully engaged in the pin receiving channel.

19. The yoke installation and removal assisting device of claim 18, wherein the fastener is a pin comprising a spring-loaded detent mechanism.

20. The yoke installation and removal assisting device of claim 17, wherein a second end of the elongated body is threaded, and wherein the locking mechanism further comprises a nut configured to removably rotationally engage the threaded end of the second end of the elongated body to secure the safety pin the in pin-receiving channel.
